(19) United States
(12) Patent Application Publication
(10) Pub. No.: US 2005/0191406 A1
(43) Pub. Date: Sep. 1, 2005

(54) Coated confectionery product

(76) Inventors: Lonette Alexander, Chicago, IL (US); James C. Clark, St. Louis, MO (US); Barbara Z. Stawski, Forest Park, IL (US); Vasek J. Kures, Willow Springs, IL (US)

Correspondence Address: WRIGLEY & DREYFUS 28455;BRINKS HOFER GILSON & LIONE, P.O. BOX 10395, CHICAGO, IL, 60610, US

(21) Appl. No.: 11/027,903

(22) Filed: Dec. 29, 2004

Related U.S. Application Data
(60) Provisional application No. 60/533,284, filed on Dec. 30, 2003.

(51) Int. Cl. A23G 3/30

(52) U.S. Cl. 426/660

(57) ABSTRACT

A coated confectionery product has a confectionery center; a first coating surrounding the center and comprising a fat; and a second coating surrounding the first coating and comprising a hard shell made from one or more sugars, polyols, high intensity sweeteners and mixtures thereof. The sugar may be selected from the group consisting of sucrose, dextrose, and maltose. Optionally a third coating may surround the second coating layer and comprise a film comprising film forming agents.

### REFERENCE TO EARLIER FILED APPLICATION

The present application claims the benefit of the filing date under 35 U.S.C. § 119(e) of Provisional U.S. Patent Application Ser. No. 60/533,284, filed Dec. 30, 2003, which is hereby incorporated by reference in its entirety.

### BACKGROUND

The present invention relates to confectionary products and particularly to confectionary products that are coated with multiple layers each having different properties.

Numerous coated confectionaries are available. Many confectionaries, such as M&M's CRISPIES, have a hard center, with a chocolate covering followed by a hard shell coating, as disclosed in U.S. Pat. No. 6,207,207. Other confectionaries, coated and non-coated, have breath-freshening properties. Some coated confectioneries have flavor in the coating layers. For example, applicants' earlier U.S. Pat. No. 6,783,783, which is incorporated by reference in its entirety, discloses a center tablet composition and coating layers having an initial mild flavor impact that increases to a more intense flavor as the product remains in the mouth. This product a compressed tablet center, a first coating layer comprising a fat, a hard shell coating, and a film coating on the outside.

Yet, additional embodiments are desirable. For example, it would be desirable if a coated product had a soft center, such as a chewy center, gummy center, soft chewy gummy center or a pressed chewy center. One problem is that such centers will typically contain higher levels of moisture than a compressed center tablet or hard center, as well as being soft. Providing multiple coatings, such as a compound coating and a hard outer shell, on such centers thus involves new challenges.

Chewy centers, compared to hard centers, have different and individual characteristics that would effect how they are coated. A pressed tablet is typically low in moisture and has a smooth surface. The soft center would be relatively high in moisture and rougher in surface. The pressed tablet would have a non-tacky surface and the soft center would have a tacky surface or an oily, slick surface. The pressed tablet would not deform during the coating process, whereas the soft center could easily deform. These characteristics of the centers effect how the coatings adhere to the center, how well the coatings create smooth, even layers around the center, and how well the finished product keeps its desired shape during coating. Also, there would be a much greater likelihood of oil or moisture migration from the center to the layers with the soft center, creating additional formula considerations with soft centers that would not exist with pressed tablet centers. Because of these differences, one can not just switch centers and keep the layers the same. Hence there is a need for multilayer coated products that provide a combination of organoleptic effects, both with compressed tablet centers and chewy centers, and for methods of masking such products.

### SUMMARY OF THE INVENTION

A coated confectionery product has been invented which provides a combination of organoleptic effects. The product includes a confectionery center; a first coating surrounding the confectionery center and comprising a fat; and a second coating surrounding the first coating and comprising a hard shell made from one or more sugars, polyols, high intensity sweeteners and mixtures thereof. The center may be a chewy center with at least 3% moisture. It has been found that such a product, if desired, can be made without the film coating applied to products disclosed in U.S. Pat. No. 6,783,783. In those embodiments, the second coating is the outermost coating of the product.

### BRIEF DESCRIPTION OF THE DRAWINGS

FIG. 1 is a partially broken away perspective view of a preferred embodiment of the present invention.

FIG. 2 is a process diagram of a preferred embodiment of the method of the present invention.

### DETAILED DESCRIPTION OF THE DRAWINGS AND PREFERRED EMBODIMENTS OF THE INVENTION

The present invention relates to a coated confectionery product which provides a combination of organoleptic effects. In one preferred embodiment, the invention relates to a coated confectionery product comprising a confectionery center, particularly a compressed tablet center.

In a second preferred embodiment, the invention relates to a coated confectionery product comprising a chewy confectionery center.

In a third preferred embodiment, the invention relates to a coated confectionery product comprising a gummy confectionery center.

In a fourth preferred embodiment, the invention relates to a coated confectionery product comprising a soft confectionery center.

In a fifth preferred embodiment, the invention relates to a coated confectionery product comprising a pressed chewy center.

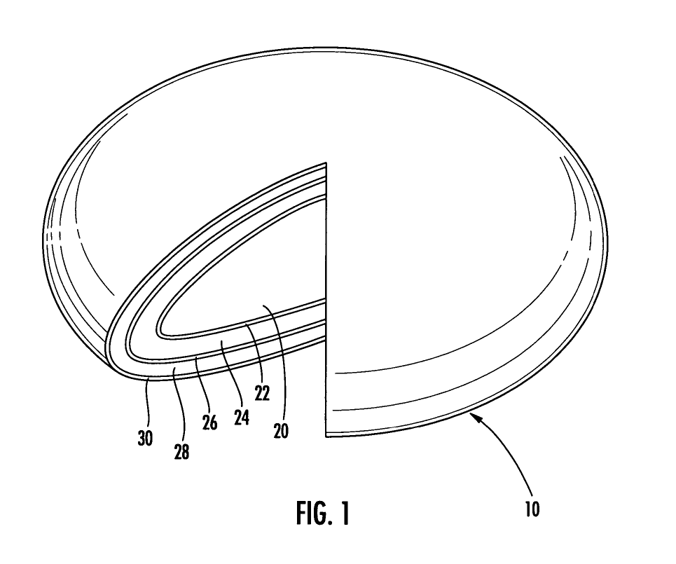

As shown in FIG. 1, a preferred coated confection 10 of the present invention comprises a confectionery center 20, a first binder layer 22, a compound coating layer 24, a second binder layer 26, a hard shell layer 28, and, optionally, a film coating layer 30.

As used herein the term “confectionery center” refers to a manmade, non-chocolate, candy center or composition. Dried fruits, nuts, coffee beans, starch based products (such as puffed or flaked cereals, cookies or biscuits) are not included in the term “confectionery center” as used in the present invention. The term “non-chocolate,” as used herein, is meant to exclude any confectionary product comprising a sweet chocolate, milk chocolate, buttermilk chocolate, bittersweet chocolate or other chocolate defined in 21 C.F.R. § 163, and is substantially free of cocoa powder. The compound coating is also non-chocolate.

The confectionery center 20 may comprise a mixture of base materials, thickeners, colorants and flavors. The base material may be a sugar or a polyol. Among the sugars that may be used are sucrose, dextrose, lactose, maltose and other common sugars. In addition, base materials may include non-sugar bulking agents. Among these are polyols such as sorbitol, maltitol, mannitol, xylitol, hydrogenated isomaltalose, lactitol, erythritol and combinations thereof. High intensity sweeteners such as acesulfame K, aspartame, alitame, sucralose, glycyrrhizin, saccharin and cyclamates may also be included with the base materials.

Thickeners include corn syrup, gelatin, pectin, and other common thickeners and are added in amounts that achieve the desired organoleptic effect. In one embodiment of the present invention, the confectionery center 20 comprises a chewy candy center. The chewy center utilized in the practice of the present invention comprises sugar, corn syrup, fat and optionally, gelatin, which provide the desired chewy texture. Preferably, the chewy center comprises gelatin in the amount of about 1% to about 2% and fat in an amount of about 4% to about 10% by weight of the center. In another embodiment of the present invention, the confectionery center 20 comprises a gummy candy center. The gummy center utilized in the practice of the present invention comprises sugar, corn syrup, gelatin and optionally, pectin, which provide the desired gummy texture. Preferably, the gummy center comprises gelatin in the amount of about 4% to about 8% and pectin in the amount of about 0.5% to about 1% by weight of the center. In an alternate embodiment of the present invention, the confectionery center 20 comprises a soft chewy or a soft gummy candy center. The soft chewy gummy center comprises sugar, corn syrup and pectin, with pectin preferably in the amount of about 0.5% to about 2%, and more preferably about 2% by weight of the center, to achieve the desired soft chewy gummy texture. In yet another alternate embodiment, the confectionery center 20 comprises a pressed chewy candy center. The pressed chewy center utilized in the practice of the present invention comprises sugar, corn syrup and fat, which provide the desired chewy texture. Preferably, the pressed chewy center comprises sugar in the amount of about 50% to about 60%, corn syrup in the amount of about 30% to about 40% and fat in the amount of about 1% to about 5% by weight of the center.

Pressed centers or pressed chewy centers may also include binders and lubricants. Binders that are commonly used are natural gums and hydrocolloids such as gum arabic, guar gum, agar, alginates, gum tragacanth, gelatin, corn syrups, modified starches, maltodextrins and optionally agglomerated dextrose. Most commonly used binders are gelatin, gum arabic or corn syrups. When non-sugar polyols such as sorbitol are used as the base material, binders are not needed for binding since many of these polyols are easily compressed to form centers. In some cases polyols such as sorbitol may also act as a binder and may be combined with sugar to form the base materials for the compressed chewy center.

Lubricants may be used to give good release from the press tooling or die and punches. A variety of lubricants or non-stick agents may be used in a pressed chewy center to act as release agents. Some of these are starch, acetylated monoglycerides, waxes, lecithins, emulsifiers, and mono-, di-, tristearates. The most common of these lubricants are magnesium or calcium stearate and stearic acid. Solid lubricants may be added to the center composition to help form the center and allow for its release. Lubricants usually comprise about 0.5% to about 2% of the center. In some instances, low levels of flow agents such as silicon dioxide are added to the pressed chewy center composition to help the flow of the mixture into the press tooling.

Flavoring agents are contemplated for use in the confectionery centers and the coatings of the present invention. Preferably flavoring agents are added at a level of about 0.01% to about 5% by weight of the confectionery center. The flavoring agents may comprise essential oils, synthetic flavors, or mixtures including but not limited to oils derived from plants and fruits such as citrus oils, fruit essences, peppermint oil, spearmint oil, clove oil, oil of wintergreen, anise and the like. Artificial flavoring components are also contemplated for use in confectionery centers of the present invention. Those skilled in the art will recognize that natural and artificial flavoring agents may be combined in any sensorially acceptable blend. All such flavors and flavor blends are contemplated by the present invention. Encapsulated flavors are also contemplated for use in the present invention.

Colors and other additives are also contemplated for use in the confectionery centers and the coatings of this invention.

Although the confectionery center 20 may be coated directly with a compound coating, the fats in the compound coating may migrate into the core. To avoid this, it is preferred to protect the core material by coating it with a first binder layer 22 to provide a protective barrier to the fats in the outer compound coating layer 24.

A compound coating comprising sugar; fat; a milk powder such as whole milk powder, non-fat milk powder or whey powder; and an emulsifier, preferably lecithin, is applied as a coating to form the non-chocolate compound coating layer 24. Preferable compound coatings may be obtained from any number of chocolate suppliers as a “white” compound coating. Compound coatings are generally described in Chapter 6 of Chocolate, Cocoa, and Confectionery: Science and Technology by B. W. Minifie, 3^{rd} Edition, incorporated herein by reference. As noted earlier, the compound coating of the present invention is a non-chocolate compound coating. Thus, the compound coating of the present invention is substantially free of sweet chocolate, milk chocolate, buttermilk chocolate, bittersweet chocolate and chocolates defined in 21 C.F.R. § 163 and cocoa powder. A preferred, compound coating is sold under the trade name WHITE KREEMY COATING™ by The Blommer Chocolate Company, Inc., Chicago, Ill. The compound coating material is obtained in solid form and melted at about 100° F. and mixed with a flavor and optionally high-intensity sweeteners, and applied in about 20-40 coating applications until the piece is increased in size by about 50-100%. As each coat is applied to the room temperature tablets, the compound coating solidifies to form a soft coating over the confectionery center. After each application, cool air may be used to accelerate the solidification of the coating. The preferred thickness of the compound coating layer will comprises about 20% to about 50% of the final product weight.

In some instances, a solid fat may be used in place of a compound coating. Suitable solid fats include triglycerides of various fatty acids, such as lauric acid, myristic acid, palmitic acid, or stearic acid. The longer the fatty acids chain length, the higher the melting point of the fat. Usually hydrogenated fats are needed since unsaturated fats have lower melting points and therefore would not give a soft-shell. Lauric acid fats are shorter in chain length and are derived from coconut and palm kernels. Non-lauric fats are longer chain fatty acids and may be derived from cocoa butter, palm oil, soybean oil and cottonseed oil. In general a suitable fat may be a combination of various fatty acid triglycerides, but should have a melting point of about 90° F. to about 140° F. Preferably, a suitable fat with a melting point of about 100° F. to about 110° F. should be used to give a suitable soft coating. Flavors and cooling agents may be added to the soft fat coating, which can be applied in a manner similar to the above described preferred compound coating. In addition, high-intensity sweeteners may be added to the soft fat coating, as well as small amounts of sugar or polyols to increase the firmness of the soft fat coating.

The soft-coated product may be coated directly with a hard shell layer 28. However, the fats in the compound coating layer 24 may migrate into the hard shell layer 28. To avoid this, it is preferred to protect the hard shell layer 28 with a second binder layer 26. In addition, to preventing the migration of materials between layers, the first and second binder layer 22, 26 also facilitate binding between the compound coating layer 24 and the adjacent layers. The binder layer is preferably made from solution of an 80/20 mixture of sugar and gum arabic in an about 50% to about 70%, and preferably 60%, solution and dried with powder 80/20 mixture of sugar and gum arabic. Alternatively, binder layers may be made using sugar or sorbitol for a sugarless product.

Next the hard shell layer 28 is applied. This layer may be a conventional hard shell sugar coating. If a sugarless product is desired, a hard shell coating can preferably be made from various polyols, such as sorbitol, xylitol and maltitol. In the preferred method of the present invention, a sugar solution is used, preferably one made with added modified starch to act as a binder. The coating may also include flavors and high-intensity sweeteners.

The coating is initially present as a liquid syrup which contains from about 30% to about 80% or 85% of coating ingredients and from about 15% or 20% to about 70% of a solvent such as water. A preferred coating syrup includes 70% sugar. The coating process may be carried out in conventional panning equipment. The soft coated tablets are placed into the panning equipment to form a moving mass. Early applications of the coating syrup are preferably done at room temperature to reduce melting of the soft coating, but warmer solutions may be used after the initial coats. After each coating, warm air is applied to dry the sugar coating.

The material or syrup which will eventually form the coating is applied or distributed over the center tablets. Flavors may be added before, during and after applying the syrup to the centers. Once the coating has dried to form a hard surface, additional syrup additions can be made to produce a plurality of coatings or multiple layers of coating.

After the initial applications, syrup is added to the center tablets at a temperature range of from about 100° F. to about 240° F. Preferably, the syrup temperature is from about 140° F. to about 200° F. Most preferably, the syrup temperature should be kept constant throughout the process in order to prevent the sweetener in the syrup from crystallizing. The syrup may be mixed with, sprayed upon, poured over, or added to the tablets in any way known to those skilled in the art.

Each component of the coating on the center may be applied in a single layer or in a plurality of layers. In general, a plurality of layers is obtained by applying single coats, allowing the layers to dry, and then repeating the process. The amount of solids added by each coating step depends chiefly on the concentration of the coating syrup. Any number of coats may be applied to the center tablet. Preferably, no more than about 75 coats are applied to the center. More preferably, less than about 60 coats are applied and most preferably, about 30 to about 60 coats are applied. In any event, the present invention contemplates applying an amount of syrup sufficient to yield a coated product containing about 10% to about 65% coating. The hard shell layer will generally comprise between about 20% and about 50% of the total product weight. Most preferably the coating layers provide a 33% increase in the weight of the tablet.

Those skilled in the art will recognize that in order to obtain a plurality of coated layers, a plurality of premeasured aliquots of coating syrup may be applied to the center. It is contemplated, however, that the volume of aliquots of syrup applied to the center may vary throughout the coating procedure.

Once a coating of syrup is applied to the center, the present invention contemplates drying the wet syrup in an inert medium. A preferred drying medium comprises air. Preferably, forced drying air contacts the wet syrup coating in a temperature range of from about 70° F. to about 110° F. More preferably, the drying air is in the temperature range of from about 80° F. to about 100° F. The invention also contemplates that the drying air possesses a relative humidity of less than about 15 percent. Preferably, the relative humidity of the drying air is less than about 8 percent.

The drying air may be passed over and admixed with the syrup coated centers in any way commonly known in the art. Preferably, the drying air is blown over and around the syrup coated centers at a flow rate, for large scale operations, of about 2800 cubic feet per minute. If lower quantities of material are being processed, or if smaller equipment is used, lower flow rates would be used. If a flavor is applied after a syrup coating has been dried, the present invention contemplates drying the flavor with or without the use of a drying medium. Coated confections are then removed from the pan coater and allowed to dry overnight.

While it is not necessary in the present invention to include a film coating, one may be applied if desired. To produce such a film coating when desired, several applications of a film coating may be applied to the sugar coated tablets to build up a film coating layer 30. The preferred film coating is made from an aqueous mixture of hydroxypropyl starch, sodium alginate, and microcrystalline cellulose, along with mint flavors and film softeners, such as glycerin. Other types of celluloses, starches, maltodextrins, gums and film forming agents may also be used to form the final coating. Optionally, high-intensity coolants may be added to the flavor, and high-intensity sweeteners or sugar or polyols may also be added to the mixture used for film coating.

Several non-limiting examples of a coated confectionery product having a chewy confectionery center of the present invention are described below and in Table 1.

### EXAMPLE 1

### Coated Confectionery Product with Chewy Center

TABLE 1
CHEWY CENTER

| Ingredients | g | % |
|---|---|---|
| Sugar | 674 | 28.15% |
| Corn Syrup 42 DE | 1120 | 46.79% |
| Fruit Juice Concentrate (65-70% | 180 | 7.52% |
| solids) | | |
| Water | 180 | 7.52% |
| Palm Kernal Oil | 147 | 6.14% |
| Gelatin, 250 bloom | 43.75 | 1.83% |
| Citric Acid | 25 | 1.04% |
| Malic acid | 7 | 0.29% |
| Flavoring | 6.55 | 0.28% |
| Monoglyceride | 4 | 0.17% |
| Lecithin | 4 | 0.17% |
| Colorant | 2.5 | 0.10% |
| Total (all) | 2393.8 | 100.0% |

| | |
|---|---|
| Ingredients | % |

COMPOUND COATING

| | |
|---|---|
| White Kreemy Coating ™ | 98.36% |
| Citric Acid | 0.79% |
| Malic Acid | 0.49% |
| Flavoring | 0.26% |
| Colorant | 0.10% |
| Total (all) | 100.0% |

HARD-SHELL COATING

| | |
|---|---|
| Sugar | 68.07% |
| Water | 27.23% |
| Modified Starch | 4.08% |
| Flavoring | 0.53% |
| Colorant | 0.09% |
| Total (all) | 100.0% |

Chewy Center Processing Instructions

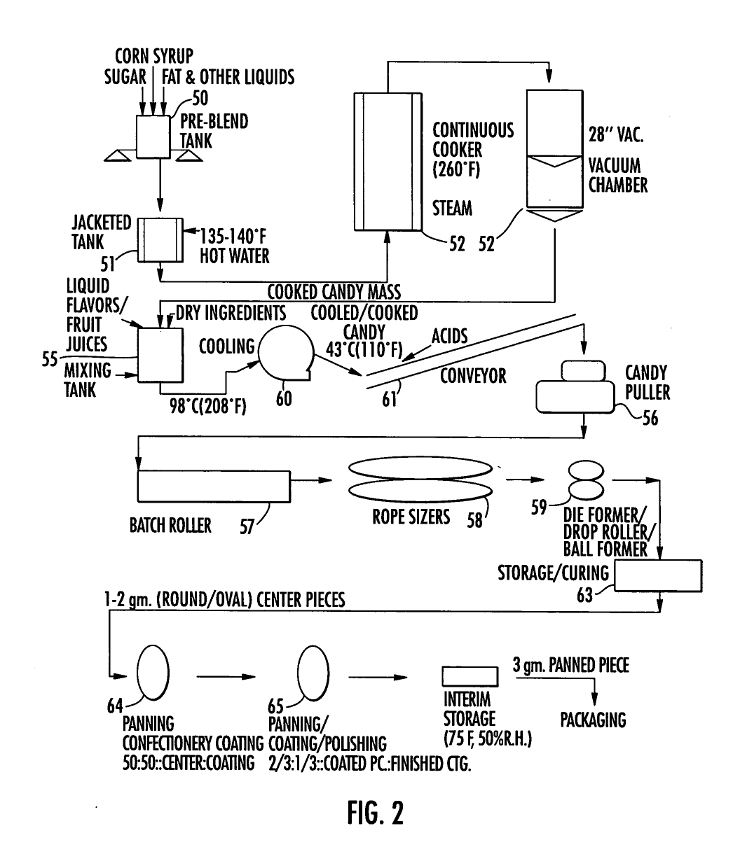

The chewy centers of Example 1 are prepared as follows, using the equipment schematic shown in FIG. 2. The gelatin is dissolved in water and added to a mixer 55. Next, a syrup is made in a vacuum cooking system 52 by continuously mixing and cooking sugar, water, and the corn syrup to a temperature of about 250° F.-275° F. As shown in FIG. 2, the sugar, corn syrup and other liquids are added to pre-blend tank 50, cooked in a jacketed mixing kettle 51 with an agitator to a temperature of about 125° F.-150° F. and cooked to a final temperature of about 250° F.-275° F. in a vacuum cooking system 52. This syrup is added to the dissolved gelatin in the mixer 55 and is blended until the mixture thickens (for about 3 minutes). The mixture is then blended at high speed until it is aerated (for about 2 minutes). Next, the mixer speed is lowered and the remaining ingredients are added to form a paste, which is mixed until homogenous (for about 2 minutes). The homogenous mixture is pumped out of the mixer by pump 60 and conveyed along conveyor 61.

The chewy centers are formed by using a puller unit 56, a batch roller 57, rope sizers 58, and/or a die former (drop roller or ball former) 59 as shown in FIG. 2. The formed chewy centers may be stored in storage 63 until the compound coating is applied using compound pan coater 64.

Compound Coating Processing Instructions

The compound coating of Table 1 comprises WHITE KREEMY COATING™ obtained from The Blommer Chocolate Company, Inc. of Chicago, Ill. The compound coating was prepared by melting the WHITE KREEMY COATING™ at about 100° F. and mixing with malic and citric acids, flavorings and colorants.

Hard-Shell Coating Processing Instructions

The hard-shell outer coating comprising sugar, water, modified starch, flavors and optionally high-intensity sweeteners is prepared as follows. A modified starch solution is formed at about 80° C., and then sugar is dissolved to form a coating syrup. After the coating syrup has cooled, flavors, colorants and optionally high-intensity sweeteners are added to the coating solution. The coating syrup is applied to the centers using a pan coater 65 as shown in FIG. 2. The hard-shell coated centers are removed from the coating pans, spread on trays and allowed to cool and dry overnight. The products made by Example 1 may then be packaged in that form, either by being individually wrapped or included as a plurality of pieces in a package. Optionally the products may be coated with a film coating after the hard shell coating before being wrapped.

### Example 1A

A coated confectionery product may be formed having a ratio of 1:1:1 of the chewy confectionery center to compound coating to hard-shell coating.

### Example 1B

A coated confectionery product may be formed having a ratio of 1:1:0.5 of the chewy confectionery center to compound coating to hard-shell coating.

Example 1C

A coated confectionery product may be formed having a ratio of 1:0.5:0.5 of the chewy confectionery center to compound coating to hard-shell coating.

Example 1D

A coated confectionery product may be formed having a ratio of 1:0.5:1 of the chewy confectionery center to compound coating to hard-shell coating.

Several non-limiting examples of a coated confectionery product having a gummy confectionery center of the present invention are described below and in Table 2.

### EXAMPLE 2

### Coated Confectionery Product with Gummy Center

TABLE 2
GUMMY CENTER

| Ingredients | g | % |
|---|---|---|
| Corn Syrup (High Maltitol) 42 DE | 150 | 27.89% |
| Sugar | 100 | 18.59% |
| Water | 180 | 33.47% |
| Sorbitol | 29.7 | 5.52% |
| Fruit Juice Concentrate (65-70% | 41 | 7.62% |
| solids) | | |
| Gelatin 200 bloom | 27 | 5.02% |
| Apple Extract Pectin | 2.7 | 0.50% |
| Citric Acid | 6 | 1.12% |
| Flavoring | 1.4 | 0.27% |
| Total (all) | 537.8 | 100.0% |

| | |
|---|---|
| Ingredients | % |

COMPOUND COATING

| | |
|---|---|
| WHITE KREEMY COATING ™ | 98.36% |
| Citric Acid | 0.78% |
| Malic Acid | 0.49% |
| Flavoring | 0.27% |
| Colorant | 0.10% |
| Total (all) | 100.0% |

HARD-SHELL COATING

| | |
|---|---|
| Sugar | 68.07% |
| Water | 27.23% |
| Modified Starch | 4.08% |
| Flavoring | 0.53% |
| Colorant | 0.09% |
| Total (all) | 100.0% |

Gummy Center Processing Instructions

The gummy center of Example 2 is prepared as follows. A syrup is prepared by cooking the corn syrup, sugar, 80 grams of the water and 27 grams of the sorbitol to a temperature of about 240° F. This syrup is cooled to a temperature of about 190° F. Meanwhile, 70 grams of water is used to dissolve the gelatin and 30 grams of water is mixed with the pectin and 2.7 grams of sorbitol. These solutions are combined and the fruit juice is added to form a second mixture. This second mixture is added slowly to the cooled syrup and mixed until a homogenous mixture is obtained. Finally, the citric acid and flavorings are added and stirred until homogenous. The resultant gummy mass is poured into starch molds, allowed to set overnight (about 24 hours) and then de-molded.

Compound Coating Processing Instructions

The compound coating of Example 2 is prepared as described in Example 1.

Hard-Shell Outer Coating Processing Instructions

The hard-shell outer coating of Example 2 is prepared as described in Example 1.

### Example 2A

A coated confectionery product may be formed having a ratio of 1:1:1 of the gummy confectionery center to compound coating to hard-shell coating.

### Example 2B

A coated confectionery product may be formed having a ratio of 1:1:0.5 of the gummy confectionery center to compound coating to hard-shell coating.

### Example 2C

A coated confectionery product may be formed having a ratio of 1:0.5:0.5 of the gummy confectionery center to compound coating to hard-shell coating.

### Example 2D

A coated confectionery product may be formed having a ratio of 1:0.5:1 of the gummy confectionery center to compound coating to hard-shell coating. Several non-limiting examples of a coated confectionery product having a soft confectionery center of the present invention are described below and in Table 3.

### EXAMPLE 3

### Coated Confectionery Product with Soft Chewy Gummy Center

TABLE 3

| | |
|---|---|
| Ingredients | % |

SOFT CENTER

| | |
|---|---|
| Sugar | 30% |
| Fruit Juice Concentrate (80% solids) | 15% |
| Water | 10% |
| Corn Syrup 43 DE | 2% |
| Pectin | 1% |
| Citric Acid | 0.5% |
| Sodium Citrate | 0.2% |
| Flavor | |
| Total (all) | 100.0% |

COMPOUND COATING

| | |
|---|---|
| WHITE KREEMY COATING ™ | 98.36% |
| Citric Acid | 0.79% |
| Malic Acid | 0.49% |
| Flavoring | 0.26% |
| Colorant | 0.10% |
| Total (all) | 100.0% |

HARD-SHELL COATING

| | |
|---|---|
| Sugar | 68.07% |
| Water | 27.23% |
| Modified Starch | 4.08% |
| Flavoring | 0.53% |
| Colorant | 0.09% |
| Total (all) | 100.0% |

Soft Center Processing Instructions

The soft chewy gummy centers of Example 3 are prepared as follows. A syrup is prepared by cooking the corn syrup, sugar and water to a temperature of about 240° F. This syrup is cooled to a temperature of about 190° F. Meanwhile, water and pectin are mixed. These solutions are combined and the fruit juice is added to form a second mixture. This second mixture is added slowly to the cooled syrup and mixed until a homogenous mixture is obtained. Finally, the citric acid, sodium citrate and flavorings are added and stirred until homogenous.

The soft chewy gummy centers are formed using starch molds. The gummy centers are allowed to set and are subsequently de-molded.

Compound Coating Processing Instructions

The compound coating of Example 3 is prepared as described in Example 1.

Hard-Shell Outer Coating Processing Instructions

The hard-shell outer coating of Example 3 is prepared as described in Example 1.

### Example 3A

A coated confectionery product may be formed having a ratio of 0.5:0.5:0.5 of the soft confectionery center to compound coating to hard-shell coating.

### Example 3B

A coated confectionery product may be formed having a ratio of 0.5:1:1 of the soft confectionery center to compound coating to hard-shell coating.

### Example 3C

A coated confectionery product may be formed having a ratio of 0.5:0.5:1 of the soft confectionery center to compound coating to hard-shell coating.

### Example 3D

A coated confectionery product may be formed having a ratio of 0.5:1:0.5 of the soft confectionery center to compound coating to hard-shell coating.

Several non-limiting examples of a coated confectionery product having a pressed chewy center of the present invention are described below and in Table 4.

### EXAMPLE 4

### Triple Coated Confectionery Product with Pressed Chewy Center

TABLE 4

| | |
|---|---|
| Ingredients | % |

PRESSED CHEWY CENTER

| | |
|---|---|
| Powder (lumpy) Mixture | 84.70% |
| comprising: | |
| Sugar (55.13%) | |
| Corn Syrup 39 DE at 45 Be′ | |
| (41.35%) | |
| Fully Hydrogenated | |
| Cottonseed Oil (1.76%) | |
| Partially Hydrogenated | |
| Vegetable Oil (1.76%) | |
| Agglomerated Dextrose | 10.16% |
| Magnesium Stearate | 0.93% |
| Silicon Dioxide | 0.25% |
| Flavoring | 0.22% |
| Flavor Beads | 3.73% |
| Total (all) | 100.0% |

COMPOUND COATING

| | |
|---|---|
| WHITE KREEMY COATING ™ | 98.36% |
| Citric Acid | 0.79% |
| Malic Acid | 0.49% |
| Flavoring | 0.26% |
| Colorant | 0.10% |
| Total (all) | 100.0% |

HARD-SHELL COATING

| | |
|---|---|
| Sugar | 68.07% |
| Water | 27.23% |
| Modified Starch | 4.08% |
| Flavoring | 0.53% |
| Colorant | 0.09% |
| Total (all) | 100.0% |

Pressed Chewy Center Processing Instructions

The pressed chewy center of Example 4 is prepared as follows. A powder mixture is prepared by adding 55.13% sugar, 41.35% corn syrup, 1.76% fully hydrogenated cottonseed oil and 1.76% partially hydrogenated vegetable oil in a plough-type shear mixer and heating the mixer to about 270° F. When the final product temperature in the mixer is about 190° F., the mixture is removed, cooled and ground. After grinding, the powder mixture is added to a dry powder blender and the remaining ingredients are added. The pressed chewy centers are formed by pressing the powder blended mixture into tablets.

Compound Coating Processing Instructions

The compound coating of Example 4 is prepared as described in Example 1.

Hard-Shell Outer Coating Processing Instructions

The hard-shell outer coating of Example 4 is prepared as described in Example 1.

### Example 4A

A coated confectionery product may be formed having a ratio of 1:1:1 of the pressed chewy confectionery center to compound coating to hard-shell coating.

### Example 4B

A coated confectionery product may be formed having a ratio of 1:1:0.5 of the pressed chewy confectionery center to compound coating to hard-shell coating.

### Example 4C

A coated confectionery product may be formed having a ratio of 1:0.5:0.5 of the pressed chewy confectionery center to compound coating to hard-shell coating.

### Example 4D

A coated confectionery product may be formed having a ratio of 1:0.5:1 of the pressed chewy confectionery center to compound coating to hard-shell coating.

### Additional Examples

Mint Tablets

The following tablet center compositions in percentages were made:

| | Example 5 | Example 6 | Example 7 | Example 8 | Example 9 | Example 10 |
|---|---|---|---|---|---|---|
| Sorbitol | 97.08 | 48.99 | 48.75 | 48.95 | 48.70 | 48.86 |
| Sugar | — | 48.99 | 48.75 | 48.95 | 48.70 | 48.86 |
| Magnesium | 1.01 | 0.75 | 0.50 | 0.50 | 0.50 | 0.50 |
| stearate | | | | | | |
| Silicon | — | — | 0.25 | 0.18 | 0.25 | 0.24 |
| Dioxide | | | | | | |
| Acesulfame K | 0.39 | — | — | — | — | — |
| Aspartame | 0.19 | — | — | — | — | — |
| SD Flavor* | — | — | — | — | 0.27 | — |
| Flavor** | 0.76 | 0.72 | 0.90 | 0.55 | 0.63 | 1.25 |
| Menthol | 0.26 | 0.25 | 0.15 | 0.15 | 0.20 | — |
| Coolant | 0.31 | 0.30 | 0.70 | 0.72 | 0.75 | 0.29 |
| Total | 100.0 | 100.0 | 100.0 | 100.0 | 100.0 | 100.0 |
| Tablet weight | 0.35 grams | 0.35 grams | 0.25 grams | 0.25 grams | 0.25 grams | 0.25 grams |

*Spray dried cinnamon flavor is used in Example 9.
**Peppermint flavor is used in Examples 5-8 and 10, and cinnamon flavor is used in Example 9.

Similar type sugarless tablet centers can be made according to the following formulas:

| | Example 11 | Example 12 | Example 13 |
|---|---|---|---|
| Sorbitol | 97.08 | — | 96.89 |
| Xylitol | | 97.78 | — |
| Magnesium stearate | 1.01 | 0.50 | 1.01 |
| Silicon Dioxide | — | — | 0.19 |
| Acesulfame K | 0.39 | 0.39 | 0.39 |
| Aspartame | 0.19 | — | 0.19 |
| Peppermint Flavor | 0.76 | 0.76 | 0.76 |
| Menthol | 0.26 | 0.26 | 0.26 |
| Coolant | 0.31 | 0.31 | 0.31 |
| Total | 100.0 | 100.0 | 100.0 |
| Tablet weight | 0.25 grams | 0.25 grams | 0.25 grams |

Soft Coating:

For Example 5-10, the tablets were then coated with a sugar/gum arabic solution at a ratio of 80/20 and at a solids level of 60%. The 80/20 powdered sugar/gum arabic was then used to dry charge the wet tablets and dry the sugar/gum arabic coating. This is used as a seal coat between the tablet layer and compound coating layer, and to act as an adhesive for the compound coating.

The above tablets for Examples 5 and 6 were then coated with a compound coating comprising sugar, vegetable oil, non-fat milk solids, lecithin, titanium dioxide, and vanilla. This material was obtained from Blommer Chocolate Co. as “Kreamy White Coating.” A different compound coating, using whey powder instead of non-fat milk solids, was used to coat the tablets of Examples 7-10. In each case, the compound coating was melted and the flavors, coolants, and high-intensity sweeteners were added to the coating mixture according to the following compositions:

| | Example 5 | Example 6 | Example 7 | Example 8 | Example 9 | Example 10 |
|---|---|---|---|---|---|---|
| Compound | 96.09 | 98.00 | 98.03 | 96.60 | 98.23 | 98.62 |
| coating* | | | | | | |
| Flavor** | 2.39 | 1.20 | 1.18 | 2.60 | 1.18 | 1.00 |
| Menthol | 0.16 | 0.20 | 0.10 | 0.15 | — | — |
| Coolant | 0.86 | 0.60 | 0.69 | 0.65 | 0.59 | 0.38 |
| Acesulfame K | 0.25 | — | — | — | — | — |
| Aspartame | 0.25 | — | — | — | — | — |
| Total | 100.0 | 100.0 | 100.0 | 100.0 | 100.0 | 100.0 |
| Piece weight | 0.70 grams | 0.70 grams | 0.40 grams | 0.40 grams | 0.40 grams | 0.45 grams |

*Non-fat milk powder is used in Examples 5 and 6; whey powder is used in Examples 7-10.
**Peppermint flavor is used in Examples 5-8 and 10; cinnamon flavor is used in Example 9.

For Examples 10-13, the tablets can be coated with the sorbitol/gum arabic solution at a ratio of 80/20 at a solids level of 60%. The 80/20 powdered sorbitol/gum arabic would then be used to dry charge the wet tablets and dry the coating to give a seal coat between the tablet layer and the next coating layer. These tablets can then be coated with a solid fat having a melting point of 110° F. (Ex. 11) or a compound coating made with xylitol (Ex. 12) or sorbitol (Ex. 13) in place of the sugar used to make typical compound coatings. Sweeteners and flavors can be added, resulting in the following formulas for the first coating layer in a sugarless product:

| | Example 11 | Example 12 | Example 13 |
|---|---|---|---|
| Compound Coating | — | 96.09 | 96.09 |
| Fat | 96.09 | — | — |
| Peppermint Flavor | 2.39 | 2.39 | 2.39 |
| Menthol | 0.16 | 0.16 | 0.16 |
| Coolant | 0.86 | 0.86 | 0.86 |
| Acesulfame K | 0.25 | 0.25 | 0.25 |
| Aspartame | 0.25 | 0.25 | 0.25 |
| Total | 100.0 | 100.0 | 100.0 |
| Piece weight | 0.40 grams | 0.40 grams | 0.40 grams |

This gives a tablet with a soft coating that contains mint flavors and coolants. Again, the soft-coated tablets were then coated with the sugar/gum arabic solution at a ratio of 80/20 at a solids level of 60%. The 80/20 powdered sugar/gum arabic was again used to dry charge the wet tablets and dry the sugar/gum arabic coating. This is used as a seal coat between the compound coating layer and the next sugar-coating layer. For Examples 11-13, a sorbitol/gum arabic mixture is used between the soft coating and the hard shell coating. Again this is used to seal the soft coating from the hard coating and act as an adhesive for the following coats.

Hard Shell Coating:

For Examples 5-10, the soft coated tablets were then coated with a hard shell sugar coating comprising sugar, starch, flavors, coolants, and optionally high-intensity sweeteners. A modified starch solution was formed at 80° C., then sugar was dissolved to form the coating syrup, and sugar syrup containing color was added. In Example 11, a sorbitol solution with gum arabic may be used to give a hard shell coating, whereas xylitol with gum arabic can be used to give the hard shell coating in Example 12. Maltitol may be used to give a hard shell coating in Example 13. The coating solution is cooled and high-intensity sweeteners are added. Flavors blended with coolants are added in several applications after the coating syrup is applied and before it is dried. Compositions of the coating mixtures used to form the second (hard shell) coating are shown in the following tables:

| | Example 5 | Example 6 | Example 7 | Example 8 | Example 9 | Example 10 |
|---|---|---|---|---|---|---|
| Sugar | 91.70 | 92.34 | 91.24 | 90.40 | 92.92 | 92.58 |
| Starch | 5.50 | 5.54 | 5.47 | 5.43 | 5.58 | 5.55 |
| Flavor* | 1.35 | 1.29 | 1.37 | 1.80 | 1.39 | 1.48 |
| Coolant | 0.85 | 0.83 | 0.11 | 0.11 | 0.11 | 0.39 |
| Sweeteners | 0.60 | — | — | — | — | — |
| Color syrup | — | — | 1.81 | 2.26 | — | — |
| Total | 100.0 | 100.0 | 100.0 | 100.0 | 100.0 | 100.0 |
| Piece weight | 0.95 grams | 0.95 grams | 0.60 grams | 0.60 grams | 0.60 grams | 0.65 grams |

*Peppermint flavor is used in Examples 5-8 and 10; cinnamon flavor is used in Example 9.

| | Example 11 | Example 12 | Example 13 |
|---|---|---|---|
| Sorbitol | 95.70 | — | — |
| Xylitol | — | 91.70 | — |
| Maltitol | — | — | 93.70 |
| Gum Arabic | 1.50 | 5.80 | 3.50 |
| Peppermint Flavor | 1.35 | 1.35 | 1.35 |
| Coolant | 0.85 | 0.85 | 0.85 |
| Intense Sweeteners | 0.60 | 0.30 | 0.60 |
| Total | 100.0 | 100.0 | 100.0 |
| Piece weight | 0.60 grams | 0.60 grams | 0.60 grams |

Hard shell coated tablets are removed from the coating pans, spread on trays and allowed to cool and dry overnight. The examples are then packaged, either by being individually wrapped, or included in a package as a group of products.

Film Coating:

The film coatings are prepared by dry blending the film forming agents of hydroxypropyl (HP) starch, sodium alginate, and microcrystalline cellulose and mixing the blend into water at a ratio of about 7:1 water:film formers. The resulting mixture is heated to about 80° C. to dissolve and disperse the film formers. The solution is then cooled, and glycerin, flavor and optionally high-intensity sweeteners or some sugar may be added to form a thick suspension. The materials may be blended together and formed into a viscous suspension by high shear mixing. Two applications of the suspension is applied to the hard shell coated product, and dried to about 10% moisture after each application. The film coating applications add about 0.1% to about 1% to the weight of the product, but give it a smooth surface and a shine. The following compositions are used for the film coating of the examples:

| | Example 5 | Example 6 | Example 7 | Example 8 | Example 9 | Example 10 |
|---|---|---|---|---|---|---|
| Flavor* | 37.80 | 37.80 | 38.79 | 39.90 | 43.11 | 53.12 |
| Menthol | 4.20 | 4.20 | 4.31 | 4.43 | — | — |
| HP starch | 34.23 | 34.23 | 34.97 | 34.23 | 34.97 | 21.55 |
| Alginate | 15.00 | 15.00 | 20.59 | 15.00 | 15.32 | 9.44 |
| Glycerin | 5.11 | 5.11 | — | 5.11 | 5.27 | 3.25 |
| Acesulfame K | 1.55 | 1.55 | — | — | — | 11.81** |
| Aspartame | 0.78 | 0.78 | — | — | — | |
| Cellulose | 1.33 | 1.33 | 1.34 | 1.33 | 1.33 | 0.83 |
| Total | 100.0 | 100.0 | 100.0 | 100.0 | 100.0 | 100.0 |

*Peppermint flavor is used in Examples 5-8 and 10; cinnamon flavor is used in Example 9.
**Sugar is used as a sweetener in place of high-intensity sweeteners in Example 10.

For Examples 11-13, any one of the film compositions shown above may be used to give a film coating on these examples.

Sensory evaluation of the products of Examples 5 through 10 indicates that the flavor and coolness of the product is very mild initially, but develops a stronger more intense flavor with cooling after a period of time. The flavor develops slowly whether the mint tablet is chewed or sucked.

Examples 6-10 are further unique in having a compressed center tablet made from equal amounts of sorbitol and sugar. This combination of materials works very well together to form a tablet. The film forming composition used in Examples 5-10 also provides especially preferred properties to the product. First, the film provides a layer that can quickly release a flavor, giving a quick initial flavor impact. Also, the flavor in this layer may give the product a desirable aroma for when a package containing the product is opened. The preferred film forming agents give an especially desirable film coating layer.

It should be appreciated that the method and products of the present invention are capable of being incorporated in the form of a variety of embodiments, only a few of which have been illustrated and described above. For example, fruit flavors may be used instead of the mint and cinnamon flavors in the examples. The invention may be embodied in other forms without departing from its spirit or essential characteristics. The described embodiments are to be considered in all respects only as illustrative and not restrictive, and the scope of the invention is, therefore, indicated by the appended claims rather than by the foregoing description. All changes that come within the meaning and range of equivalency of the claims are to be embraced within their scope.

1. A coated confectionery product comprising:
a) a confectionery center;
b) a first coating surrounding the confectionery center and comprising a fat; and
c) a second coating surrounding the first coating and comprising a hard shell made from one or more sugars, polyols, high intensity sweeteners and mixtures thereof.

2. The confectionery product of claim 1 further comprising a third coating covering the second coating, the third coating comprising a film comprising film forming agents.

3. The confectionery product of claim 1 further comprising a binder coating between the confectionery center and the first coating, said binder coating comprising a binder.

4. The confectionery product of claim 1 further comprising a binder coating between the first and second coatings, the binder coating comprising a binder.

5. The confectionery product of claims 3 wherein said binder coating further comprises a sweetener and said binder is selected from the group consisting of natural gums, hydrocolloids and mixtures thereof.

6. The confectionery product of claim 5 wherein said sweetener is selected from the group consisting of sugars, polyols, high intensity sweeteners and mixtures thereof.

7. The confectionery product of claims 4 wherein said binder coating further comprises a sweetener and said binder is selected from the group consisting of natural gums, hydrocolloids and mixtures thereof.

8. The confectionery product of claim 7 wherein said sweetener is selected from the group consisting of sugars, polyols, high intensity sweeteners and mixtures thereof.

9. The confectionery product of claim 1 wherein said first coating comprises a compound coating.

10. The confectionery product of claim 9 wherein said compound coating comprises a sweetener, said fat, a milk powder and an emulsifier.

11. The confectionery product of claim 10 wherein said sweetener is selected from the group consisting of sucrose, sorbitol and mixtures thereof.

12. The confectionery product of claim 1 wherein said hard shell coating is made from a sugar selected from the group consisting of sucrose, dextrose, maltose and mixtures thereof.

13. The confectionery product of claim 1 wherein said hard shell coating is made from a polyol selected from the group consisting of sorbitol, maltitol, xylitol, hydrogenated isomaltalose, lactitol, erythritol and mixtures thereof.

14. The confectionery product of claim 10 wherein said milk powder is selected from the group consisting of whole milk powder, non-fat milk powder, whey powder and mixtures thereof.

15. The confectionery product of claim 1 wherein said confectionery center comprises about 20% to about 50% of the confectionery product.

16. The confectionery product of claim 1 wherein said first coating comprises about 20% to about 50% of the confectionery product.

17. The confectionery product of claim 1 wherein said second coating comprises about 20% to about 50% of the confectionery product.

18. A coated confectionery product comprising:
a) a confectionery center;
b) a first binder coating covering the confectionery center;
c) a compound coating surrounding the first binder coating, the compound coating comprising:
i) a fat;
ii) a milk powder;
iii) a sweetener selected from the group consisting of sucrose, sorbitol and mixtures thereof; and
iv) an emulsifier;
d) a second binder coating covering the first coating; and
c) a hard-shell coating surrounding the second binder coating, the hard-shell coating made from one or more sugars, polyols, high intensity sweeteners and mixtures thereof.

19. The confectionery product of claim 18 further comprising a film coating covering the hard-shell coating, the film coating comprising film forming agents.

20. The confectionery product of claim 18 wherein said first and second binder coatings comprise:
i) a sweetener selected from the group consisting of sugar, sorbitol and mixtures thereof; and
ii) a binder selected from the group consisting of gum arabic, modified starch and mixtures thereof.

21. A coated confectionery product comprising:
a) a chewy confectionery center;
b) a first coating covering the chewy center, the first coating comprising a fat; and
c) a second coating covering the first coating, the second coating comprising a hard shell coating made from one or more sugars and polyols;
wherein said chewy confectionery center comprises sugar, corn syrup and fat.

22. The confectionery product of claim 21 further comprising a third coating covering the second coating, the third coating comprising a film comprising film forming agents.

23. The confectionery product of claim 21 further comprising a binder coating between the chewy confectionery center and the first coating.

24. The confectionery product of claim 21 further comprising a binder coating between the first and second coatings.

25. The confectionery product of claim 21 wherein said first coating comprises a compound coating.

26. The confectionery product of claim 25 wherein said compound coating comprises a sweetener, said fat, a milk powder and an emulsifier.

27. The confectionery product of claim 26 wherein said sweetener is selected from the group consisting of sucrose, sorbitol and mixtures thereof.

28. The confectionery product of claim 26 wherein said milk powder is selected from the group consisting of whole milk powder, non-fat milk powder, whey powder and mixtures thereof.

29. The confectionery product of claim 21 wherein said chewy confectionery center further comprises gelatin.

30. The confectionery product of claim 29 wherein said gelatin comprises about 1% to about 2% by weight of the chewy confectionery center.

31. The confectionery product of claim 21 wherein said chewy confectionery center comprises about 33% to about 50% by weight of the confectionery product.

32. The confectionery product of claim 21 wherein said first coating comprises about 20% to about 40% by weight of the confectionery product.

33. The confectionery product of claim 21 wherein said second coating comprises about 20% to about 50% by weight of the confectionery product.

34. A coated confectionery product comprising:
a) a chewy confectionery center comprising fat the amount of about 4% to about 10% by weight of the chewy confectionery center and gelatin in the amount of about 1% to about 2% by weight of the chewy confectionery center;
b) a first binder coating covering the chewy confectionery center;
c) a compound coating surrounding the first binder coating, the compound coating comprising:
i) a fat;
ii) a milk powder;
iii) a sweetener selected from the group consisting of sucrose, sorbitol and mixtures thereof; and
iv) an emulsifier;
d) a second binder coating covering the first coating;
c) a hard-shell coating surrounding the second binder coating, the hard-shell coating made from one or more sugars, polyols, high intensity sweeteners and mixtures thereof.

35. The confectionery product of claim 34 further comprising a film coating covering the hard-shell coating, the film coating comprising film forming agents selected from the group consisting of celluloses, starches, maltodextrins, gums and mixtures thereof.

36. The confectionery product of claim 34 wherein said first and second binder coatings comprise:
i) a sweetener selected from the group consisting of sugar, sorbitol and mixtures thereof; and
ii) a binder selected from the group consisting of gum arabic, modified starch and mixtures thereof.

37. A method of producing the coated confectionery product of claim 34 comprising the steps of:
a) providing a chewy confectionery center;
b) forming a first binder coating over the chewy confectionery center by applying a binder solution having a solids level of about 50% to about 70% over the chewy confectionery center and then applying a powdered binder mixture to dry charge the chewy confectionery center;
b) forming a compound coating over the first binder coating by applying multiple coats of a molten compound coating over the chewy confectionery center, with cooling between coats to solidify the compound coating;
c) forming a second binder coating over the chewy confectionery center by applying at least one layer of a binder solution having a solids level of about 50% to about 70% over the compound coated chewy confectionery center and then applying a powdered binder mixture to dry charge the compound coated chewy confectionery center; and
d) applying a hard-shell coating over the second binder coating by panning the compound coated chewy center by applying multiple coats of a panning syrup comprising a sugar, a polyol or mixtures thereof.

38. The method of claim 37 further comprising the step of:
e) applying a film coating over the hard-shell coating by applying multiple coats of a syrup containing one or more film forming agents.

39. A coated confectionery product comprising:
a) a gummy confectionery center;
b) a first coating covering the gummy confectionery center, the first coating comprising a fat; and
c) a second coating covering the first coating, the second coating comprising a hard shell coating made from one or more sugars and polyols.

40. The confectionery product of claim 39 further comprising a third coating covering the second coating, the third coating comprising a film comprising film forming agents.

41. The confectionery product of claim 39 further comprising a binder coating between the gummy confectionery center and the first coating.

42. The confectionery product of claim 39 further comprising a binder coating between the first and second coatings.

43. The confectionery product of claim 39 wherein said first coating comprises a compound coating.

44. The confectionery product of claim 43 wherein said compound coating comprises a sweetener, said fat, a milk powder and an emulsifier.

45. The confectionery product of claim 39 wherein said gummy confectionery center comprises gelatin.

46. The confectionery product of claim 45 wherein said gummy confectionery center further comprises pectin.

47. The confectionery product of claim 46 wherein said pectin comprises about 0.5% to about 1% and said gelatin comprises about 4% to about 8% by weight of the gummy confectionery center.

48. The confectionery product of claim 39 wherein said gummy confectionery center comprises about 33% to about 50% by weight of the confectionery product.

49. The confectionery product of claim 39 wherein said first coating comprises about 20% to about 40% by weight of the confectionery product.

50. The confectionery product of claim 39 wherein said second coating comprises about 20% to about 40% by weight of the confectionery product.

51. A coated confectionery product comprising:
a) a gummy confectionery center comprising pectin in the amount of about 0.5% to about 1% and gelatin in the amount of about 4% to about 8% by weight of the gummy confectionery center;
b) a first binder coating covering the gummy confectionery center;
c) a compound coating surrounding the first binder coating, the compound coating comprising:
i) a fat;
ii) a milk powder;
iii) a sweetener selected from the group consisting of sucrose, sorbitol and mixtures thereof; and
iv) an emulsifier;
d) a second binder coating covering the first coating; and
c) a hard-shell coating surrounding the second binder coating, the hard-shell coating made from one or more sugars, polyols, high intensity sweeteners and mixtures thereof.

52. The confectionery product of claim 51 further comprising a film coating covering the hard-shell coating, the film coating comprising film forming agents selected from the group consisting of celluloses, starches, maltodextrins, gums and mixtures thereof.

53. The confectionery product of claim 51 wherein said first and second binder coatings comprise:
i) a sweetener selected from the group consisting of sugar, sorbitol and mixtures thereof; and
ii) a binder selected from the group consisting of gum arabic, modified starch and mixtures thereof.

54. A method of producing the coated confectionery product of claim 51 comprising the steps of:
a) providing a gummy confectionery center;
b) forming a first binder coating over the gummy confectionery center by applying a binder solution having a solids level of about 50% to about 70% over the gummy confectionery center and then applying a powdered binder mixture to dry charge the gummy confectionery center;
b) forming a compound coating over the first binder coating by applying multiple coats of a molten compound coating over the gummy confectionery center, with cooling between coats to solidify the compound coating;
c) forming a second binder coating over the compound coated gummy confectionery center by applying at least one layer of a binder solution having a solids level of about 50% to about 70% over the compound coated gummy confectionery center and then applying a powdered binder mixture to dry charge the compound coated gummy confectionery center; and
d) applying a hard-shell coating over the second binder coating by panning the compound coated gummy center by applying multiple coats of a panning syrup comprising a sugar, a polyol or mixtures thereof.

55. The method of claim 54 further comprising the step of:
e) applying a film coating over the hard-shell coating by applying multiple coats of a syrup containing one or more film forming agents.

56. A coated confectionery product comprising:
a) a soft chewy gummy confectionery center;
b) a first coating covering the soft chewy gummy confectionery center, the first coating comprising a fat; and
c) a second coating covering the first coating, the second coating comprising a hard shell coating made from one or more sugars and polyols.

57. The confectionery product of claim 56 further comprising a third coating covering the second coating, the third coating comprising a film comprising film forming agents.

58. The confectionery product of claim 56 further comprising a binder coating between the soft chewy gummy confectionery center and the first coating.

59. The confectionery product of claim 56 further comprising a binder coating between the first and second coatings.

60. The confectionery product of claim 56 wherein said first coating comprises a compound coating.

61. The confectionery product of claim 60 wherein said compound coating comprises a sweetener, said fat, a milk powder and an emulsifier.

62. The confectionery product of claim 56 wherein said soft chewy gummy confectionery center comprises pectin.

63. The confectionery product of claim 62 wherein said pectin comprises about 2% by weight of the soft chewy gummy confectionery center.

64. The confectionery product of claim 56 herein said soft chewy gummy confectionery center comprises about 20% to about 33% by weight of the confectionery product.

65. The confectionery product of claim 56 wherein said first coating comprises about 25% to about 50% by weight of the confectionery product.

66. The confectionery product of claim 56 wherein said second coating comprises about 25% to about 50% by weight of the confectionery product.

67. A coated confectionery product comprising:
a) a soft chewy gummy confectionery center comprising pectin in the amount of from about 0.5% to about 2% by weight of the soft confectionery center;
b) a first binder coating covering the soft confectionery center;
c) a compound coating surrounding the first binder coating, the compound coating comprising:
i) a fat;
ii) a milk powder;
iii) a sweetener selected from the group consisting of sucrose, sorbitol and mixtures thereof; and
iv) an emulsifier;
d) a second binder coating covering the first coating; and
c) a hard-shell coating surrounding the second binder coating, the hard-shell coating made from one or more sugars, polyols, high intensity sweeteners and mixtures thereof.

68. The confectionery product of claim 67 further comprising a film coating covering the hard-shell coating, the film coating comprising film forming agents selected from the group consisting of celluloses, starches, maltodextrins, gums and mixtures thereof.

69. The confectionery product of claim 67 wherein said first and second binder coatings comprise:
i) a sweetener selected from the group consisting of sugar, sorbitol and mixtures thereof; and
ii) a binder selected from the group consisting of gum arabic, modified starch and mixtures thereof.

70. A method of producing the coated confectionery product of claim 67 comprising the steps of:
a) providing a soft chewy gummy confectionery center;
b) forming a first binder coating over the soft chewy gummy confectionery center by applying a binder solution having a solids level of about 50% to about 70% over the soft chewy gummy confectionery center and then applying a powdered binder mixture to dry charge the soft chewy gummy confectionery center;
b) forming a compound coating over the first binder coating by applying multiple coats of a molten compound coating over the soft chewy gummy confectionery center, with cooling between coats to solidify the compound coating;
c) forming a second binder coating over the compound coated soft chewy gummy confectionery center by applying at least one layer of a binder solution having a solids level of about 50% to about 70% over the compound coated soft chewy gummy confectionery center and then applying a powdered binder mixture to dry charge the compound coated soft chewy gummy confectionery center; and
d) applying a hard-shell coating over the second binder coating by panning the compound coated soft chewy gummy center by applying multiple coats of a panning syrup comprising a sugar, a polyol or mixtures thereof.

71. The method of claim 70 further comprising the step of:
e) applying a film coating over the hard-shell coating by applying multiple coats of a syrup containing one or more film forming agents.

72. A coated confectionery product comprising:
a) a pressed chewy confectionery center;
b) a first coating covering the pressed chewy confectionery center, the first coating comprising a fat; and
c) a second coating covering the first coating, the second coating comprising a hard shell coating made from one or more sugars and polyols.

73. The confectionery product of claim 72 further comprising a third coating covering the second coating, the third coating comprising a film comprising film forming agents.

74. The confectionery product of claim 72 further comprising a binder coating between the pressed chewy confectionery center and the first coating.

75. The confectionery product of claim 72 further comprising a binder coating between the first and second coatings.

76. The confectionery product of claim 72 wherein said first coating comprises a compound coating.

77. The confectionery product of claim 76 wherein said compound coating comprises a sweetener, said fat, a milk powder and an emulsifier.

78. The confectionery product of claim 72 wherein said pressed chewy confectionery center comprises sugar, corn syrup and fat.

79. The confectionery product of claim 78 wherein said sugar comprises about 50% to about 60% and said corn syrup comprises about 30% to about 40% and said fat comprises about 1% to about 5% by weight of the pressed chewy confectionery center.

80. The confectionery product of claim 72 wherein said pressed chewy confectionery center comprises about 33% to about 50% by weight of the confectionery product.

81. The confectionery product of claim 72 wherein said first coating comprises about 20% to about 40% by weight of the confectionery product.

82. The confectionery product of claim 72 wherein said second coating comprises about 20% to about 40% by weight of the confectionery product.

83. A coated confectionery product comprising:
a) a pressed chewy confectionery center comprising sugar in the amount of about 50% to about 60%, said corn syrup in the amount of about 30% to about 40% and said fat in the amount of about 1% to about 5% by weight of the pressed chewy confectionery center;
b) a first binder coating covering the pressed chewy confectionery center;
c) a compound coating surrounding the first binder coating, the compound coating comprising:
i) a fat;
ii) a milk powder;
iii) a sweetener selected from the group consisting of sucrose, sorbitol and mixtures thereof; and
iv) an emulsifier;
d) a second binder coating covering the first coating; and
c) a hard-shell coating surrounding the second binder coating, the hard-shell coating made from one or more sugars, polyols, high intensity sweeteners and mixtures thereof.

84. The confectionery product of claim 83 further comprising a film coating covering the hard-shell coating, the film coating comprising film forming agents selected from the group consisting of celluloses, starches, maltodextrins, gums and mixtures thereof.

85. The confectionery product of claim 83 wherein said first and second binder coatings comprise:
i) a sweetener selected from the group consisting of sugar, sorbitol and mixtures thereof; and
ii) a binder selected from the group consisting of gum arabic, modified starch and mixtures thereof.

86. A method of producing the coated confectionery product of claim 83 comprising the steps of:
a) providing a pressed chewy confectionery center;
b) forming a first binder coating over the pressed chewy confectionery center by applying a binder solution having a solids level of about 50% to about 70% over the pressed chewy confectionery center and then applying a powdered binder mixture to dry charge the pressed chewy confectionery center;
b) forming a compound coating over the first binder coating by applying multiple coats of a molten compound coating over the pressed chewy confectionery center, with cooling between coats to solidify the compound coating;
c) forming a second binder coating over the compound coated pressed chewy confectionery center by applying at least one layer of a binder solution having a solids level of about 50% to about 70% over the compound coated pressed chewy confectionery center and then applying a powdered binder mixture to dry charge the compound coated pressed chewy confectionery center; and
d) applying a hard-shell coating over the second binder coating by panning the compound coated pressed chewy center by applying multiple coats of a panning syrup comprising a sugar, a polyol or mixtures thereof.

87. The method of claim 86 further comprising the step of
e) applying a film coating over the hard-shell coating by applying multiple coats of a syrup containing one or more film forming agents.
